(19) United States
(12) Patent Application Publication
(10) Pub. No.: US 2014/0255898 A1
(43) Pub. Date: Sep. 11, 2014

(54) Assessing Reading Comprehension And Critical Thinking Using Annotation Objects

(71) Applicant: Pandexio, Inc., Hermosa Beach, CA (US)

(72) Inventors: John Richard Burge, Manhattan Beach, CA (US); Jack Levy, Hermosa Beach, CA (US)

(73) Assignee: Pandexio, Inc., Hermosa Beach, CA (US)

(21) Appl. No.: 14/201,521

(22) Filed: Mar. 7, 2014

Related U.S. Application Data
(60) Provisional application No. 61/775,297, filed on Mar. 8, 2013.

(51) Int. Cl. G09B 5/08

(52) U.S. Cl. CPC G09B 5/08
USPC 434/350

(57) ABSTRACT

A competency assessment system enables reading comprehension and critical thinking skills of a knowledge worker to be assessed. The competency assessment system enables a knowledge worker to create an assertion map based on one or more source literals. The assertion map comprises several assertion objects that link to different portions of the source literals or other assertion objects. The competency assessment system compares the assertion map created by the knowledge worker with another assertion map to assess the worker's reading comprehension and critical thinking skills.

This application claims the benefit of U.S. Provisional Application No. 61/775,297, filed Mar. 8, 2013. This and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is knowledge assessment, particularly, assessment of reading comprehension or critical thinking of knowledge workers.

### BACKGROUND

The following description includes information that may be useful in understanding the present invention. It is not an admission that any of the information provided herein is prior art or relevant to the presently claimed invention, or that any publication specifically or implicitly referenced is prior art.

As countries around the world transition from industrial-based economies to knowledge-based economies, it is increasingly important to develop more efficient and effective methods for assessing the reading comprehension and critical thinking performance of knowledge workers. Unlike industrial workers, knowledge workers do not often produce tangible products. Instead, knowledge workers are paid to attain and generate knowledge to make decisions, or make recommendations to others so they can make decisions. Reading remains the primary way in which they generate and transfer knowledge. As a result, the ability of individuals to comprehend documents they read is crucial to a knowledge economy, as is their ability to assimilate and synthesize what they have learned across multiple documents, and critically evaluate how it applies to their context.

In educational contexts, reading comprehension has historically been assessed through students writing reports or taking retrospective written or oral exams. Similar methods have been used for assessing critical thinking. These assessment methods are highly manual, and represent relatively indirect ways of measuring reading comprehension and critical thinking. While certain standardized tests such as the SAT and ACT contain sections designed to assess these skills, and apply a more automated grading approach, they involve numerous drawbacks as well. They are similarly indirect, introduce test biases such as test-taking, are sporadically administered and taken, and are not incorporated into a student's normal activities (represent an entirely separate process). Surprisingly, in knowledge worker contexts, reading comprehension and critical thinking capabilities tend to escape formal assessment. In general, these knowledge worker capabilities are usually not assessed at time of hiring or as an ongoing part of assessing performance or helping improve it.

Efforts have been made in assessing and tracking knowledge. For example, U.S. Pat. No. 7,630,867 issued to Behrens, entitled “System and Method for Consensus-Based Knowledge Validation, Analysis and Collaboration”, issued Dec. 8, 2009, discloses comparing two knowledge maps that represent competency of the same set of panelists over a period of time to show changes in competency within the panelists. U.S. Patent Publication 2009/0035733 to Meitar et al., entitled “Device, System, and Method of Adaptive Teaching and Learning”, published Feb. 5, 2009, discloses creating knowledge maps for students before and after a learning event, and comparing the knowledge map to track learning progress of the students. U.S. Pat. No. 6,768,982 issued to Collins entitled “Method and System for Creating and Using Knowledge Patterns”, issued Jul. 27, 2004, discloses annotating (i.e., creating metadata for) knowledge maps.

While these ideas address comparing and analyzing knowledge maps to assess competency/knowledge of people using a system of nodes and links, they do not address the assessment of individuals reading comprehension and critical thinking skills against specific document sets they process as they learn or work. Thus, there is still a need for a system capable of efficiently evaluating or assessing a knowledge worker's competency (e.g., comprehension competency, critical thinking competency, etc.).

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### SUMMARY OF THE INVENTION

The inventive subject matter provides apparatus, systems and methods in which a knowledge worker's competency can be assessed. In some embodiments, the system comprises an annotation database that stores a first set of annotation objects associated with a first literal and a second set of annotation objects associated with a second literal. A literal is defined herein as any portion of a specific content (e.g., video, audio, written, verbal, text, etc.) such as a book, an audio-book, a portion of a book, an article, a publication, a website, a manual, a source code, a process, or other types of content, including multi-modal content.

The system also comprises a competency assessment engine that is coupled with the annotation database. The competency assessment engine is configured to obtain a first knowledge map that is defined based on the first set of annotation objects, and a second knowledge map that is defined based on the second set of annotation objects. The competency assessment engine is also configured to identify differences between the first and second knowledge maps and to generate an assessment report based on the identified differences. The competency assessment engine is configured to then configure an output device to present the assessment report. The knowledge maps can be considered a representation of knowledge workers analysis of a target subject matter. The assessment report represents a comparison or contrast of the knowledge maps and their relative merit with respect to the target subject matter.

The knowledge maps can be represented in different ways. In some embodiments, each of the first and second knowledge maps is represented by a graph comprising nodes and links related to the associated set of annotation objects. In these embodiments, each node in the graph comprises at least one annotation object. The node can also include other additional information related to the annotation objects, such as a frequency of usage of the annotation object and user number and types of user interactions with the annotation object.

In some embodiments, the identified differences between the first and second knowledge maps can comprise a difference in nodes between the first and second knowledge maps. For example, a difference in nodes can include different annotation objects based on the same literal, different usage metrics, or different user interactions on the nodes. The identified differences between the first and second knowledge maps can also comprise a difference in links.

In some embodiments, the assessment report comprises an assessment score that quantify a competency assessment based on a knowledge map. The assessment score can have multiple dimensions. For example, the assessment score can include a competency score that indicates a competency with respect to comprehension of a literal, and a score that indicates a competency with respect to critical thinking based on a literal. In other embodiments, the assessment report comprises a difference knowledge map.

The competency assessment system of some embodiments can be used for different kinds of assessment. For example, the system can be used to compare how two people annotate the same literal (e.g., comparing a student's annotation to a model annotation of the same literal). The system can also be used to generate a trend or trait of an annotation style by comparing annotation objects of two different literals.

In some embodiments, the first set of annotation objects is created by a knowledge worker. In these embodiments, the first knowledge map includes an owner identifier that indicates the identity of the knowledge worker (e.g., an employee, a student, a teacher, a standard, or an organization). The system can further comprise a recommendation engine that is configured to offer a recommendation with respect to the knowledge worker based on the assessment report. For example, the first set of annotation objects can be created by an interviewee during a job interview, the recommendation can include whether to hire that knowledge worker based on the assessment report.

The competency assessment system of some embodiments also includes a navigation interface that is configured to allow navigation of the first and second knowledge maps. The system can also include a knowledge map assessment dashboard that is configured to render the assessment report.

In some embodiments, the system can compare a knowledge worker's competency with other knowledge workers (e.g., comparing competency within a department or group, within a company, peer to peer, worker to manager, etc.). The system can also include a knowledge worker feedback interface that is configured to provide assessment to the knowledge worker in relation to other knowledge workers.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a schematic overview of a possible competency assessment system.

FIG. 2 is a schematic of a possible annotation object.

FIG. 3 presents a possible knowledge map generated by a set of annotation objects.

FIG. 4 presents an alternative possible knowledge map generated by a different set of annotation objects.

FIG. 5 illustrates a possible difference knowledge map.

### DETAILED DESCRIPTION

It should be noted that any language directed to a computer should be read to include any suitable combination of computing devices, including servers, interfaces, systems, databases, agents, peers, engines, modules, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. Further, the term “configured to” is used euphemistically to represent “programmed to” within the context of a computing device.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within a networking context the terms “coupled to” and “coupled with” are used to represent “communicatively coupled with” where two or more networked devices are able to exchange data over a network.

The inventive subject matter provides apparatus, systems and methods in which the competency of a knowledge worker (e.g., a student, an employee, an interviewee, etc.) can be assessed. In some embodiments, the system comprises an annotation database that stores a first set of annotation objects associated with a first literal and a second set of annotation objects associated with a second literal. A literal is defined herein as any piece of content, as referenced earlier, (written or verbal) such as a book, an audio-book, an article, a publication, a website, a manual, a source code, a process, etc.

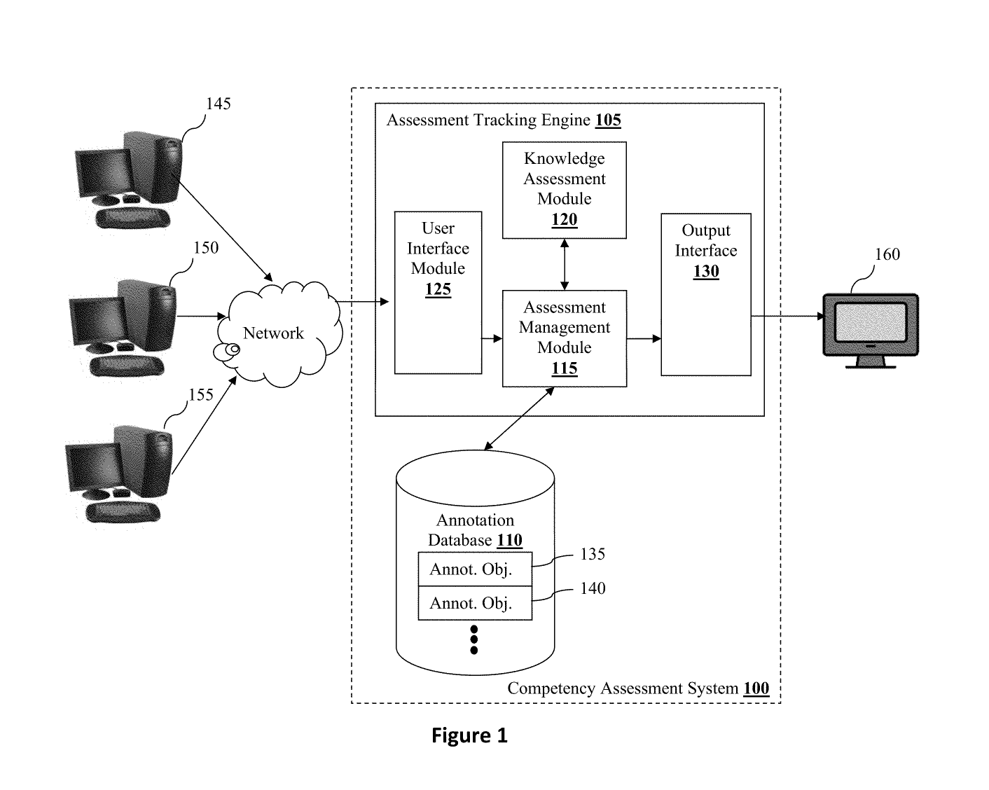

FIG. 1 illustrates a competency assessment system 100 of some embodiments. In this figure, the competency assessment system 100 comprises an annotation database 110 for storing annotation objects and a competency assessment engine 105. In some embodiments, the competency assessment engine 105 is communicatively coupled with the annotation database. The annotation database 110 of some embodiments is implemented as a server that stores the annotation objects on a non-transitory permanent data storage such as a hard drive, RAID system, SAN, NAS, a flash memory, etc. In some embodiments, the annotation database 110 can be a file system, database management system, one or more binary large object (BLOB), a document, a table, etc. In some embodiments, the annotation database 110 stores assertion objects within or as annotation object that are associated with a plurality of different assertions made by users.

As shown in the figure, the annotation database 110 stores multiple annotation objects, such as annotation object 135 and annotation object 140. Each of the annotation objects represents a relationship between an annotation and an information source (e.g., literal). For example, an annotation object can represent a fact or a point that is supported by an information source. Another annotation object can represent an opinion or a conclusion that is derived from an information source. Yet another assertion object can represent an observation or a perception that is based on an information source. In some embodiments, the annotation objects can be implemented as metadata object having similar structure and relationship among other metadata objects as described in co-owned U.S. patent application 61/739,367 entitled “Metadata Management System”, filed Dec. 19, 2012 and U.S. patent application 61/755,839 entitled “Assertion Quality Assessment and Management System”, filed Jan. 23, 2013.

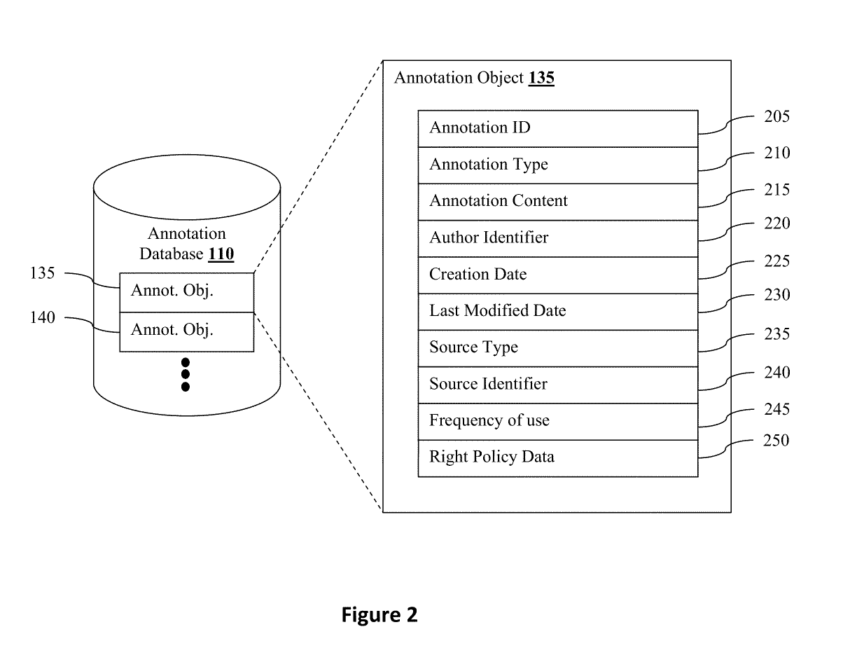

Each annotation object also includes a set of attributes. FIG. 2 illustrates an example annotation object in more detail. Specifically, FIG. 2 shows annotation object 135 and annotation object 140 that are stored in the annotation database 110. FIG. 2 also illustrates a set of attributes that is stored within the annotation object 135. As shown, annotation object 135 includes an annotation ID 205, an annotation type 210, annotation content 215, an author identifier 220, a creation date 225, a last modified date 230, a source type 235, a source identifier 240, frequency of use 245, and right policy data 250. These attributes only represent examples of the kinds of attributes that can be included within an annotation object. The annotation objects of some embodiments can have more or less attributes than this set to better suit a particular situation.

The annotation ID 205 is used to uniquely identify an annotation object. It can be used as a reference identifier when it is referenced by another annotation object. It can also be used for identifying the annotation object and retrieving the annotation object from the annotation database 110.

The annotation type 210 of an annotation object can be used to indicate a type of the annotation. As mentioned above, each annotation object represents a relationship between an annotation and an information source (e.g., a fact, a point, an opinion, conclusion, perspective, etc.). Thus, the annotation type 210 of some embodiments can indicate an annotation type of the assertion object.

The annotation content 215 stores the “annotation” of the annotation object. In some embodiments, the content is a word, a phrase, a sentence, a paragraph, or an essay. The annotation (or the annotation content) is generated by a user who has read another piece of content (i.e., the information source). The user then creates the annotation content (e.g., a point, an opinion, a conclusion, an observation, a point, an asserted fact, etc.) based on the information source. In some embodiments, the information source can be at least a portion of a literal (e.g., a book, an article, a website, etc.) or another annotation object.

The author identifier 220 identifies the author (e.g., a knowledge worker) of the annotation. The identifier can be a name, a number (e.g., social security number), or a string of characters. The competency assessment system 100 of some embodiments can include another database that stores information of different authors. The competency assessment system 100 can then retrieve the author's information by querying the database using the author identifier.

The creation date 225 and the last modified date 230 indicate the date that the author created the annotation object and the date that the author last modified the object, respectively.

The source type 235 indicates the type of source information that is associated with this annotation object. For example, as mentioned above, the information source can be a literal (e.g., a book, an article, a website, etc.) or another annotation object. The source type 235 can contain information that indicates the type of the source information.

The source identifier 240 identifies the information source that is associated with the annotation object. As mentioned above, the information source can be another annotation object that is also stored in the annotation database 110. In this case, the source identifier 240 can be the annotation ID of the other annotation object. In other cases, the source identifier 240 can be an identifier of a document ID such as a digital object identifier (DOI), a URL, an IP address, document coordinates (e.g., page, line, column, section, etc.), a time stamp, or other type of address that could point to a specific piece of content. The source identifier 240 can also be a pointer that directly points to another object within the annotation database 110.

In some embodiments, the annotation object can include more than one information source (e.g., when an annotation is derived from a combination of more than one information sources). In these embodiments, the annotation object can store more than one source type/source identifier pairs.

Frequency of use 245 is a metric for the annotation object that can be updated automatically by the competency assessment engine 105 during the lifespan of the annotation object. Frequency of use 245 attribute stores a value that indicates the number of times the annotation object has been accessed. The competency assessment engine 105 automatically stores the value 0 when the annotation object is first instantiated, and updates the value whenever the annotation object is accessed by a user.

Rights policy data 250 includes information that indicates which users have access to the annotation object. In some embodiments, it can include a list of users who have access to the annotation object (i.e., a white list), or a list of users who are excluded from accessing the annotation object (i.e., a black list). In other embodiments, it can indicate a specific access level (e.g., top security, public, group, etc.) so that only users who have clearance of a specific access level can access the annotation object.

Referring back to FIG. 1, the competency assessment engine 105 includes an assessment management module 115, a knowledge assessment module 120, a user interface module 125, and an output interface 130. The user interface module 125 communicates with computing devices 145, 150, and 155 over a network (e.g., a local area network, the Internet, etc.). Users behind the computing devices 145, 150, and 155 can create annotation objects by providing inputs to the competency assessment system 100 via the user interface module 125.

When the competency assessment engine 105 receives a triggering event for creating an annotation object (e.g., selecting a button, highlighting a section of an e-book, etc.), the competency assessment engine 105 instantiates a new annotation object. The author (e.g., a knowledge worker) who creates the annotation object can provide the annotation content, identification of the source (e.g., annotation ID of another annotation object, identify of a source literal object, other identifier of the source literal, etc.) for the newly created annotation object.

Some of the other attributes of the annotation object can be generated automatically by the competency assessment engine 105. The competency assessment engine 105 then stores the annotation object in the annotation database 110. At least some of these attributes can be updated or modified during the lifetime of the object. Each annotation object is distinctly manageable apart from its information source. For example, the annotation object 135 can be retrieved from the annotation database independent of its information source. The user can view and modify the content of the annotation object independent of the information source. The annotation object can also be independently published (either in paper form or digital form) without referring to the information source.

Having the characteristics described above, annotation objects created by an author can be linked together to form a graph with nodes and links. The nodes of the graph are the annotation objects created by the author(s) or the literal objects representing the source literals. The links of the graph are pointers from one annotation object to its information source (e.g., to another annotation object or to a literal object). In some embodiments, such an annotation graph represents a synthesis structure of knowledge that is derived from one or more information sources. Thus, the annotation graph can also be characterized as a knowledge map representing the author's comprehension of one or more source literals or the author's critical thinking based on one or more source literals. In some embodiments, the competency assessment engine 105 is configured to use the attributes of the different annotation objects to generate a knowledge map (either automatically or initiated by user's request).

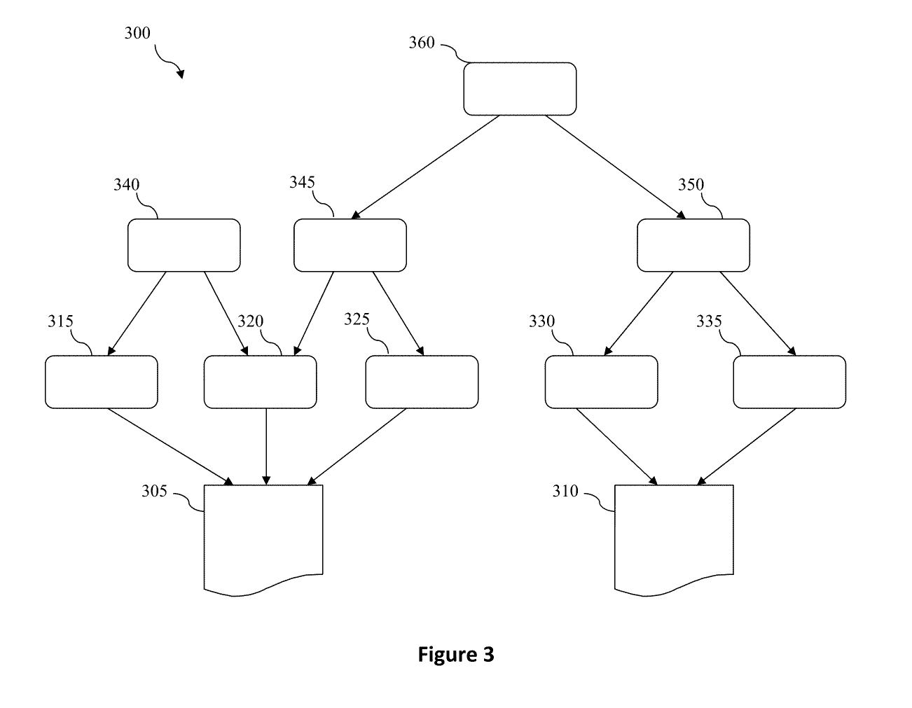

FIG. 3 illustrates an example knowledge map 300 generated by the competency assessment engine 105. In this figure, the knowledge map 300 is created based on two different literal sources, as shown by the two literal objects 305 and 310 in the knowledge map 300. The two literal sources 305 and 310 can represent two different literals (e.g., two different books, publications, articles, or websites, etc.) or two different sections (e.g., two different sentences, paragraphs, or chapters, etc.) of the same literal.

The knowledge map 300 also includes annotation objects 315-360. As mentioned before, an annotation object can be created based on a literal (e.g., a book, a publication, etc.). In this example, the graph 300 shows that annotation objects 315, 320, and 325 all point to the literal represented by source literal object 305. Similarly, annotation objects 330 and 335 both point to source literal object 310.

In addition, an annotation object can also be created based on other annotation objects. As shown in the graph 300, annotation object 340 identifies annotation objects 315 and 320 as its information source, indicating that the annotation 340 is generated/derived based on annotations 315 and 320. Similarly, annotation objects 345 points to annotation objects 320 and 325 as its information source, and annotation object 350 points to annotation objects 330 and 335 as its information source.

Furthermore, an annotation object can also be associated with (directly or indirectly) more than one source literal. For example, annotation object 360 points to annotation objects 345 and 350 as its information source. In this case, annotation objects 345 and 350 are indirectly associated with different literals—source literal object 305 and source literal object 310, respectively.

As knowledge maps provide a concrete (i.e., definable and measurable) way to represent an author's comprehension of literals or critical thinking based on the literals, it allows comparison between comprehension or critical thinking between two people by comparing the knowledge maps created by the two people. For instance, a knowledge map generated by a student based on a novel can be compared to a model knowledge map generated by a teacher (or an education organization). A knowledge map generated by an employee can also be compared to another knowledge map generated by another employee to assist in performance review, ability assessment by the employees' manager.

In one example, the knowledge map 300 in FIG. 3 can represent a model knowledge map created by a teacher based on a novel. In this example, the teacher created the model knowledge map 300 using a set of pre-determined criteria. The set of pre-determined criteria can include (1) identify new characters, (2) identify traits of the characters, (3) identify common traits between characters, (4) identify setting, (5) identify conflict, (6) identify metaphor, (7) identify conflict resolution, and so forth.

Thus, the source literal objects 305 and 310 can represent portions of the novel identified by the teacher to have met any one of the set of pre-determined criteria. In some embodiments, the teacher can identified portions of the novel by identifying the phrase, sentence, or paragraph (i.e., using page and line number, by drawing a boundary around the text, etc.), which will be used as the source identifier 240 of the annotation object. The teacher can then tag the portions of the novel with one of the criteria, which will become the annotation type 210 and annotation content 215 of the annotation object. The annotation objects 315-360 represent the teacher's notes (or answers) for the pre-determined criteria.

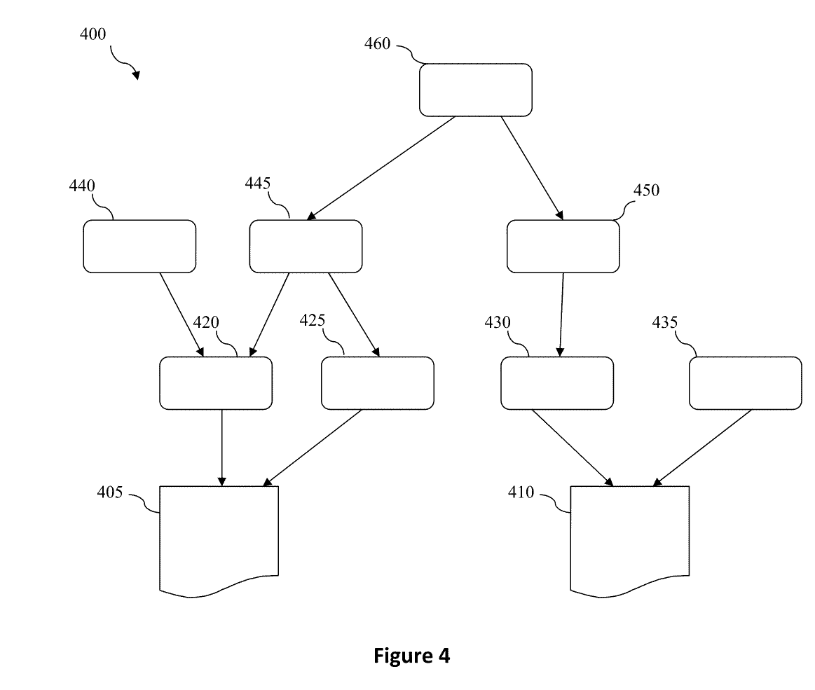

After creating the model knowledge map, the teacher can proceed to ask his/her students to annotate the novel based on the same set of pre-determined criteria. Potentially, each student may annotate a little differently from other students, and also differently from the teacher. FIG. 4 illustrates an example knowledge map 400 created by one of the students based on the novel. In this figure, the knowledge map 400 includes two source literal objects 405 and 410.

The knowledge map 400 also includes annotation objects 415-460. Specifically, annotation objects 420 and 325 point to the literal represented by source literal object 405. Similarly, annotation objects 430 and 435 point to source literal object 410. Furthermore, annotation object 440 identifies annotation object 420 as its information source, indicating that the annotation 440 is generated/derived based on annotation 420. Similarly, annotation object 445 points to annotation objects 420 and 425 as its information source, and annotation object 450 points to annotation object 430 and 435 as its information source. Lastly, annotation object 460 points to annotation objects 445 and 450.

Referring back to FIG. 1, the assessment management module 115 of some embodiments is configured to obtain two or more knowledge maps generated based on annotation objects stored in the annotation database 110, and use the knowledge assessment module to compare the two or more knowledge maps.

In some embodiments, the knowledge assessment module 120 can perform a comparison between knowledge maps in different ways. One way to compare two knowledge maps is by identifying overlaps (e.g., percentage of overlaps, etc.) or differences (e.g., percentage of differences, etc.) between the knowledge maps. Overlaps occur when (1) an annotation object in the student's knowledge map and an annotation object in the teacher's model knowledge map share the same source identifier (i.e., both the teacher and the student identify the same portion of the novel) and (2) the annotation object in the student's knowledge map has the same annotation type and/or content as the annotation object of the teacher's model knowledge map (i.e., both the student and the teacher tag that portion of the novel the same way). Using this approach to compare the knowledge maps 300 and 400, the knowledge assessment module 120 can identify that compared against knowledge map 300, knowledge map 400 is missing annotation object 315 (and also the link between annotation object 315 and literal object 305, and the link between annotation object 340 and annotation object 315). The knowledge assessment module 120 can also identify that knowledge map 400 is missing a link between annotation object 350 and annotation object 355.

In addition to comparing the overlapping of nodes and links, the knowledge assessment module 120 of some embodiments can also compare the metrics of the nodes between the two knowledge maps. As mentioned above, the annotation objects can include metrics that the competency assessment engine 105 tracks throughout the lifespan of the annotation objects. Examples of such metrics include frequency of use among workers, number of links, size of node (e.g., memory required for storage of annotation content), difference among nodes, or other metrics. Thus, the knowledge assessment module 120 of some embodiments can compare the knowledge maps by comparing the metrics between corresponding nodes (corresponding annotation objects) of the two knowledge maps.

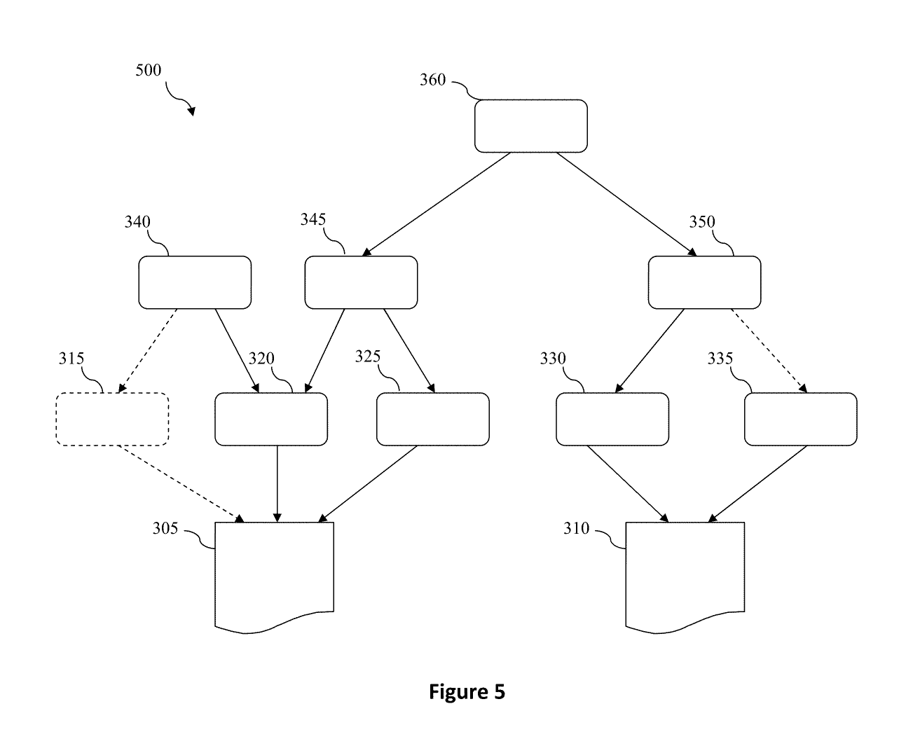

Based on this comparison, the knowledge assessment module 120 can generate an assessment report for the knowledge map 400. The assessment report in some embodiments comprises an assessment score that quantifies a competency assessment of the student with respect to the student's comprehension or critical thinking based on the novel. The assessment report of some other embodiments can include a difference knowledge map, which can help the teacher identify area(s) in which the student needs help. FIG. 5 illustrates an example of a difference knowledge map generated by the knowledge assessment module 120 based on the comparison between knowledge map 300 and knowledge map 400.

As shown in FIG. 5, a difference knowledge map is very similar to an actual knowledge map, except that it includes additional information such as which node (annotation object) and link (pointer to another annotation object or literal object) is being overlapped, which node and link is missing from the knowledge map being assessed, and which node and link is extra in the knowledge map being assessed. In this figure, the nodes and links that are overlapped between knowledge map 300 and knowledge map 400 are shown with solid lines, and nodes and links that are missing from the knowledge map 400 are shown with dotted lines. Since there are no nodes or links that are extra in knowledge map 400, none is shown, or else they can be shown with a different line pattern.

In addition to assessment score and different knowledge map, the knowledge assessment module 120 of some embodiments can also generate a recommendation based on the comparison. For example, the recommendation can include suggestions of a certain lesson or practice for the student to work on.

In some embodiments, the competency assessment engine also provides a navigation interface via the output device through which the user (e.g., the teacher) can navigate the knowledge map that the user has created, the knowledge maps that others (e.g., the students) have created, and also the difference knowledge maps.

Once an assessment report is generated, the assessment management module 115 is configured to render the assessment report and to configure an output device (e.g., monitor 160) to present the assessment report to a user (e.g., the teacher).

The above example demonstrates a comparison between a model knowledge map and a knowledge map created by a knowledge worker (e.g., a student), which is suitable in an educational environment. In other environments, such as office and business environments, the competency assessment system 100 can also be used to compare knowledge maps that are generated by different knowledge workers (e.g., different employees). In this situation, the comparison of knowledge maps can indicate a difference in levels of competency between employees, or an employee's competency level with respect to the competency level of a group of employees (e.g., within a department, within a team, etc.). The assessment report for the employees can allow the manager to determine promotion, job placement, and additional training that targets a particular employee.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system for assessing competency of a knowledge worker, comprising:
an annotation database configured to store a first set of annotation objects associated with a first literal and a second set of annotation objects associated with a second literal;
a competency assessment engine coupled with the annotation database and configured to:
obtain a first knowledge map defined based on the first set of annotation objects and a second knowledge map defined based on the second set of annotation objects;
identify differences between the first and second knowledge maps;
generate an assessment report based on the differences; and
configure an output device to present the assessment report.

2. The system of claim 1, wherein each of the first and second knowledge maps is represented by a graph comprising nodes and links related to the associated annotation objects.

3. The system of claim 2, wherein the differences between the first and second knowledge maps comprise a difference in nodes between the first and second knowledge maps.

4. The system of claim 2, wherein the differences between the first and second knowledge maps comprise a difference in links.

5. The system of claim 2, wherein each node in the node graph comprises at least one annotation object and a usage metric indicating a frequency of usage of the annotation object, wherein the differences comprise different usage metrics between the nodes of the first and second knowledge maps.

6. The system of claim 5, wherein the usage metric of each node are time dependent based on user interactions with the annotation object, wherein the differences further comprise different temporal changes in the usage metrics between the nodes of the first and second knowledge maps.

7. The system of claim 1, wherein the assessment report comprises an assessment score.

8. The system of claim 7, wherein the assessment score comprises a critical thinking score.

9. The system of claim 7, wherein the assessment score comprises a comprehension score.

10. The system of claim 1, wherein the assessment report comprises a difference knowledge map.

11. The system of claim 1, wherein the first literal associated with the first knowledge map and the second literal associated with the second knowledge map are the same literal.

12. The system of claim 1, wherein the first literal associated with the first knowledge map and the second literal associated with the second knowledge map are different literals.

13. The system of claim 1, wherein the first literal is a book.

14. The system of claim 1, wherein the annotation objects associated with the first literal is created by the knowledge worker, wherein the competent assessment engine further comprises a recommendation module configured to offer a recommendation with respect to the knowledge worker based on the assessment report.

15. The system of claim 1, further comprising a navigation interface configured to allow navigation of the first and second knowledge maps.

16. The system of claim 1, further comprising a knowledge map assessment dashboard configured to render the assessment report.

17. The system of claim 16, wherein the dashboard comprises a knowledge worker feedback interface configured to provide assessment to the knowledge worker in relation to other knowledge workers.

18. The system of claim 1, wherein the first literal comprises at least one of the following: an article, a web site, a publication, a manual, a source code, and a process.

19. The system of claim 1, wherein the first knowledge map comprises an owner identifier.

20. The system of claim 19, wherein the owner identifier represents an owner of the first knowledge map as at least one of the following: an employee, a student, a teacher, a standard, and an organization.
